(19) United States
(12) Patent Application Publication
(10) Pub. No.: US 2011/0129335 A1
(43) Pub. Date: Jun. 2, 2011

(54) Rotor Assembly for a Reheat Steam Turbine

(76) Inventors: Göran Axelsson, Katrineholm (SE); Jari Nyqvist, (US); Rickard Ortsaeter, Norrkoping (SE); Jan Persson, Finspang (SE); Rolf Wikström, Finspong (SE)

(21) Appl. No.: 12/956,038

(22) Filed: Nov. 30, 2010

(30) Foreign Application Priority Data
Dec. 1, 2009 (EP) 09014911.3

(51) Int. Cl. F01D 11/08; F04D 29/00; F01D 1/02; B23P 15/04

(52) U.S. Cl. 415/173.1; 416/198 R; 415/198.1; 29/889.21

(57) ABSTRACT

A caseless rotor assembly is provided. The caseless rotor assembly includes a rotor shaft, a high pressure portion with a high pressure rotor blade, a low pressure portion with a low pressure rotor blade, and a common wall between the high pressure portion and the low pressure portion. The common wall extends radially from the rotor shaft. The common wall itself includes a shaft end oriented towards the rotor shaft and an outer end on the other side of the common wall, oriented radially outwards. Additionally, the common wall surrounds circularly the rotor shaft.

### CROSS REFERENCE TO RELATED APPLICATIONS

This application claims priority of European Patent Office application No. 09014911.3 EP filed Dec. 1, 2009, which is incorporated by reference herein in its entirety.

### FIELD OF INVENTION

The present invention relates to the field of reheat steam turbines, and more particularly to a caseless rotor assembly for a reheat steam turbine. The invention relates further to a reheat steam turbine as well as to a method for fabrication of a caseless rotor assembly for a reheat steam turbine.

### ART BACKGROUND

In the field of electrical power generation energy efficiency is a key requirement. Higher oil and gas prices and the awareness of greenhouse effect are contributing to an increasing demand for renewable energy in the portfolio of many utilities. One way to contribute to the sustainability of the environment and its energy resources is in the implementation of industrial steam turbine solutions for alternative energy applications. For waste-to-energy, solar power and biomass, a number of proven solutions already illustrate the capacity of steam turbine driven generators. Waste-to-energy is a process by which forestry and agricultural waste (biomass) and municipal solid waste (garbage) is incinerated at high temperatures producing high temperature gas to produce steam, which then passes under high pressure through a steam turbine to create electricity. Because the cost of the fuel in waste-to-energy facilities is virtually non-existent, it represents a viable energy alternative to fossil fuels which are non-renewable and cost money. A typical boiler fired with fresh wood generates high steam parameter values, mainly high temperatures (480-540° C.) of the steam. Reheat solutions may be using the above described boiler. The reheat concept is based on live steam running through a high pressure (HP) turbine. Before entering a low pressure (LP) turbine, the steam is returned to the steam generator to increase its temperature to the live steam parameters (basically, pressure remains as is).

The general reheat process works as follows: A heat recovery steam generator behind the boiler produces superheated steam at high temperature and high pressure. The exact parameters vary, depending on the type of plant in which the process is used. The steam is admitted into the HP turbine. In the turbine, there are several stages with rotating blades where the steam will expand as the steam pressure reduces after each stage. In each stage, the high pressure steam streams against rotating high pressure rotor blades and forces the rotor to move. In-between the rotor blades there may be high pressure diaphragms provided in order to guide the stream between different rotor blades.

From the HP-turbine exhaust, the steam is taken back into the steam generator for re-heating in order to raise the temperature of the low pressure steam back to the original temperature. The reheat steam is now admitted into a separate low pressure (LP) turbine to generate further power in a set of stages. Finally, the steam enters into a vacuum condenser were the remaining steam is condensed. The residing water is pumped back into the steam generator to generate the steam used in the closed loop process. Typically, the two turbine modules (HP, LP) are connected to an electrical generator providing power to consumers via a power grid. In the case of a three stage turbine design, there may be a high pressure module, an intermediate pressure (IP) module and a low pressure module provided.

One requirement of modern turbines is a compactness of the turbine design. Also typical for modern turbines is a barrel design. In order to achieve compactness using a barrel design, at least two modules (e.g. HP-LP, HP-IP or IP-LP) are combined in one casing. In order to separate modules operating at different pressures (e.g., high pressure (HP), intermediate pressure (IP), or low pressure (LP)), a wall within a casing separates the two modules. Typically, in such a design a split plane is used that is attached and supported by casing parts of the high and the low pressure module.

A couple of advantages have made reheat steam turbines popular in power generation solutions. Reheat steam turbines may be manufactured in a joint casing design, composed of several casing parts, reducing the cost of the turbine itself. Plant construction costs may be reduced because of reduced turbine size and shortened delivery times. The advantage of a joint-casing is particularly notable on the single-shaft design in reducing total shaft length, improving shaft system reliability due to the reduced number of rotors and enhancing operability and maintainability.

Thus, there may be a need for providing an alternative rotor assembly for a reheat steam turbine allowing an easy and cost effective way of fabrication of a reheat steam turbine.

### SUMMARY OF THE INVENTION

This need may be met by a caseless rotor assembly, a reheat steam turbine, and a method for fabrication of a caseless rotor assembly according to the independent claims. Advantageous embodiments are described by the dependent claims.

According to a first exemplary aspect there is provided a caseless rotor assembly comprising a rotor shaft, a high pressure portion with a high pressure rotor blade, a low pressure portion with a low pressure rotor blade, and a common wall between the high pressure portion and the low pressure portion. The common wall extends radially from the rotor shaft. The common wall itself comprises a shaft end oriented towards the rotor shaft and an outer end on the other side, oriented radially outwards. Additionally, the common wall surrounds circularly the rotor shaft. Moreover, the common wall may optionally be composed of two or more individual parts, particularly each extending axially. Also alternatively, the common wall may be composed of several individual parts, each for a specific circle segment.

According to a further exemplary aspect, a reheat steam turbine is provided which comprises a rotor assembly, as described above, and a stator assembly, comprising a casing surrounding the caseless rotor assembly. The casing comprises a high pressure chamber and a low pressure chamber, wherein the common wall separates the high pressure chamber and the low pressure chamber. In this way, the high pressure chamber and the low pressure chamber may be effectively separated in a barrel single-casing design. The two sealings, in particular the rotor sealing and the casing sealing, together with the common wall may isolate the high pressure chamber and the low pressure chamber of the reheat steam turbine.

Again, according to another exemplary aspect, there is a method provided for the fabrication of a caseless rotor assembly as described above, wherein the method comprises the steps of providing a rotor shaft with a high pressure section and a low pressure section, mounting a high pressure rotor blade, in particular a plurality of high pressure rotor blades, onto the high pressure section of the rotor shaft, providing or mounting a common wall that extends radially from the rotor shaft, and mounting a low pressure rotor blade, in particular a plurality of low pressure rotor blades, onto the low pressure section of the rotor shaft. A rotor assembly, fabricated as just described, may easily be fitted into a casing for a reheat steam turbine. The fabrication process may be made easier and more cost-effective because a separating wall—or walls—between different modules is not to be mounted separately from the rotor assembly to the casing.

The expression “caseless rotor assembly” may denote that the rotor assembly is caseless, i.e., that no casing is positioned around the rotor assembly, however it already comprises all necessary rotor blades for the high pressure portion and the lower pressure portion. Furthermore, such a caseless rotor assembly comprises already a common wall that builds a separating wall between a high pressure chamber and a lower pressure chamber if the caseless rotor assembly is positioned inside a casing. This is in contrast to a conventional design, wherein a rotor assembly comprising on the high pressure rotor blade(s) is firstly positioned in a casing. After this step, a closing wall closes the high pressure module. Additionally, a lower pressure module closing wall is necessary basically facing the high pressure closing wall. After the providing of the lower pressure module closing wall the lower pressure rotor blades are fixed to the respective rotor shaft portion. At the end, two separate casing closing wall and two casing parts—one for the high pressure module and another one for the lower pressure module—are required in the conventional casing design.

The expression “separate the high pressure chamber against the low pressure chamber” might be understood in the sense that it is not a hermetic isolation in the sense of a vacuum tight sealing. A tight sealing may be provided between the casing end of the common wall and a casing. On the other hand it may be possible that steam flows between the shaft and the shaft end of the common wall.

An advantage of such a caseless rotor assembly design may be in the option to mount the caseless rotor assembly and a casing for the HP module combined with an IP or LP module using a barrel design more or less independently from each other. A rotor shaft may be equipped with a high pressure rotor blade, in particular with a plurality of high pressure rotor blades, with a common wall, and additionally, with a low pressure rotor blade, in particular with a plurality of low pressure rotor blades. In this way, the common wall may be mounted on the rotor shaft between the one or more high pressure rotor blades and the one or more low pressure rotor blades. The high pressure rotor blade may be mounted onto a high pressure section of the rotor shaft. The low pressure rotor blade may be mounted onto the low pressure section of the rotor shaft.

Such a complete rotor assembly may then be mounted into a single casing for a HP module and a lower pressure module (e.g., IP or LP). This design approach may help reducing the effort for a manufacturing of a reheat steam turbine because the caseless rotor assembly, together with the common wall, may be mounted into the single casing, wherein the common wall separates a high pressure chamber (or module) and a low pressure chamber (or module) from each other.

It should also be noted that the common wall may be composed out of at least two or four parts covering a circle segment each, such that the common wall may be mounted easily in a way to completely surround the shaft. This way the common wall does not need to be pushed over the shaft in one piece and be positioned in its destination portion of the shaft.

In the following, further exemplary embodiments of the rotor assembly will be described. However, these embodiments also apply for the reheat steam turbine and the method for fabrication of a rotor assembly.

In one embodiment, the common wall and the rotor shaft may be rotatable against each other. That means that the common wall may freely rotate around the rotor shaft if not fixed elsewhere. In this way, the common wall—once inserted into the casing as part of the rotor assembly—may be fixed to the casing. Even if such a fixation is done, the rotor shaft may still rotate freely inside the casing.

In another embodiment, a high pressure diaphragm, in particular a plurality of high pressure diaphragms may be provided in the high pressure portion of the caseless rotor assembly. Such a diaphragm may guide the steam to the high pressure rotor blade for better efficiency of a turbine. In case there is more than one high pressure rotor blade, high pressure diaphragms may be positioned between the rotor blades.

In again another embodiment, a low pressure diaphragm is provided in the low pressure portion of the rotor assembly having equivalent characteristics as the high pressure diaphragms in the high pressure portion of the caseless rotor assembly.

In yet another embodiment, the high pressure diaphragm, the low pressure diaphragm and the common wall are fixed against each other by a diaphragm carrier as part of the caseless rotor assembly. Such a complete assembly of the diaphragms and the common wall may be part of a stator of a turbine as it may be fixed to the casing so that it does not rotate, but only the rotor together with the rotor blade rotates inside the casing.

In another embodiment, the common wall is L-shaped with two legs. One leg may extend axially relative to the rotor shaft along the shaft end of the common wall and the other leg may extend radially from the shaft end of the common wall towards the outer or opposite end of the common wall. It may help to guide steam from a low pressure intake into the low pressure chamber, if the L-shape is directed towards the low pressure chamber.

Such a design may also help guiding expanded steam in the high pressure chamber towards a high pressure outlet of the high pressure module, if the L-shape is directed towards the high pressure chamber.

Additionally, if the L-shaped common wall is directed to the high pressure chamber, a second L-shaped element may be directed towards the low pressure chamber guiding incoming steam from a low pressure intake into the direction of the low pressure rotor blades. The two L-shaped elements, in particular the common wall and the L-shaped element of the low pressure module, may be attached back-to-back to the leg of the common wall that extends towards the outer end of the common wall.

In a further embodiment of the rotor assembly, the rotor assembly may comprise a rotor sealing between the rotor shaft and the shaft end of the common wall. Despite the rotating rotor shaft and a non-rotating common wall relative to a casing, into which the rotor assembly may be mounted, the rotor sealing may tighten the high pressure chamber or module against the low pressure chamber or module in an adjacent area between the rotor shaft and the common wall.

The expression “separate the high pressure chamber or module against the low pressure chamber or module” might be understood in the sense that it is not a hermetic isolation in the sense of a vacuum tight sealing but a sealing that is used with turbine rotor shafts known as labyrinths.

Again in another embodiment, the rotor sealing may be a common sealing strip, in particular a plurality of common sealing strips. The one or more common sealing strips may guarantee a good separation of the high pressure chamber and the low pressure chamber. This may be advantageous for a high efficiency of the reheat steam turbine because the rotor shaft may freely rotate within the common wall, and the high pressure chamber and the low pressure chamber are effectively tightened or sealed against each other. For this purpose, the common wall may have grooves at the shaft end oriented perpendicular to the axis of the shaft comprising sealing elements. In the same area of the rotor shaft there may be brush-like elements fixed to the shaft that engage with grooves of the sealing element of the common wall. It should be noted that the brush-like elements do not touch the bottom of the grooves of the sealing element of the common wall but leave a space, for example a space in the range of about 0.1 to 0.2 mm through which a low fraction of steam from one side of the common wall may stream to the other side of the common wall.

It is noteworthy that the low pressure chamber is characterized by a lower operating steam pressure compared to the high pressure chamber. However, in a multistage, e.g., three or four stage, reheat steam turbine design, the second stage after the high pressure module may be an intermediate pressure module. In this sense, the expression low pressure module should not be restricted to the module of the lowest pressure, but only point out the circumstance that the module operates at a lower pressure compared to a higher pressure module. In this context, there may also be an embodiment in which an intermediate pressure module and a low pressure module are separated by the common wall that may be positioned between the intermediate pressure module and the low pressure module in the common IP-LP-casing.

In one embodiment, the outer end of the common wall may comprise a casing sealing. Such a casing sealing may tighten a gap between the common wall and the casing. Such a casing sealing may be a means for tightening the high pressure chamber against the low pressure chamber in the above discussed sense. The high pressure chamber, as well as the low pressure chamber, may be basically formed by the casing and the common wall, which may be on one end tightened towards the rotor shaft by the rotor sealing, i.e., a sealing strip, and on the other end towards the casing by the casing sealing.

In again another embodiment, the casing sealing may be a piston ring, in particular a plurality of piston rings. The use of piston rings may have the advantage that the rotor assembly can easily be fitted into and fixed at the casing. In the area or region of a correctly positioned rotor assembly including the common wall there may be a projection formed on the inner circumference or periphery of the casing. This way, the piston ring may be positioned between the outer end of the common wall and the casing. By pressing the piston ring, particularly a plurality of piston rings, together, or compress it, or scrunch it, the rotor assembly may be fitted into the casing. Once the pressure on the piston ring, respectively piston rings, is released, the piston ring(s) may press against the projection of the casing on an inner circumference of the casing, thereby tightening or sealing a gap between the common wall and the casing. This may advantageously separate the high pressure chamber from the low pressure chamber. In this case, the sealing may be completely tight in contrast to the sealing at the shaft end of the common wall.

It has to be noted that embodiments of the invention have been described with reference to different subject matters. In particular, some embodiments have been described with reference to method type claims, whereas other embodiments have been described with reference to apparatus type claims. However, a person skilled in the art will gather from the above and the following description that, unless otherwise notified, in addition to any combination of features belonging to one type of subject matter also any combination between features relating to different subject matters, in particular between features of the method type claims, and features of the apparatus type claims, is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment, but to which the invention is not limited.

### BRIEF DESCRIPTION OF THE DRAWINGS

FIG. 1 shows an abstract model of a reheat steam turbine.

FIG. 2 shows an embodiment of a rotor assembly together with a reheat steam turbine.

FIG. 3 shows a magnification of a core part of FIG. 2 focusing on the rotor shaft, the common wall, the casing projection, as well as the sealings.

### DETAILED DESCRIPTION

The illustration in the drawings is schematic. It should be noted that in different figures, similar or identical elements are provided with the same reference signs or with reference signs, which are different from the corresponding reference signs only within the first digit.

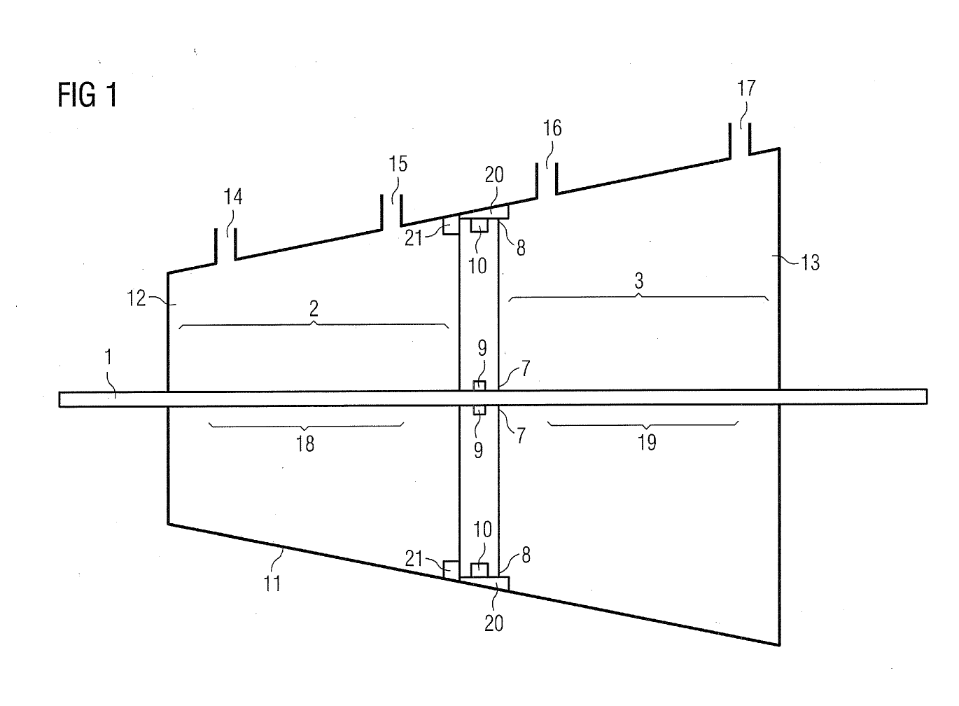

FIG. 1 shows an abstract model of a reheat steam turbine. Centrally, a rotor shaft 1 is shown. A casing of the reheat steam turbine is basically separated into a left and a right compartment or module. The left compartment represents a high pressure chamber 12, and is building—together with all other components belonging to a high pressure chamber of a reheat steam turbine—the high pressure module.

The right compartment represents a low pressure chamber 13, and may form—together with all other components belonging to a low pressure chamber of a reheat steam turbine—the low pressure module.

The high pressure chamber 12 and the low pressure chamber 13 are separated by a common wall 6. Part of the high pressure chamber 12 is a high pressure inlet 14 through which superheated live steam at high temperature and high pressure from the boiler is led into the high pressure chamber 12.

As part of the high pressure portion 2 of the rotor assembly in a high pressure section 18 of the rotor shaft 1, there may be at least one high pressure rotor blade provided (not shown in FIG. 1).

Superheated live steam makes thus the high pressure rotor blades 4 together with the rotor shaft 1 rotate. Thereby, the superheated live steam is expanding and losing temperature. The somewhat cooled down and expanded steam leaves the high pressure chamber 12 via high pressure outlet 15 or high pressure exhaust. From the high pressure exhaust the steam is led back into a reheat unit for re-heating and raising the temperature of the relative low pressure steam back to the original temperature. The reheated steam is then admitted into the low pressure chamber 13 through a low pressure inlet 16.

Optionally, there may be more than one rotor blade provided on the rotor shaft in the axial direction. In order to guide the steam from one rotor blade to the next rotor blade arranged further downstream in the high pressure chamber, a high pressure diaphragm may be provided between the two high pressure rotor blades. If more than two rotor blades stages are provided also more high pressure diaphragms could be provided between the rotor blades stages. It should be noted that none of the mentioned diaphragms are shown in FIG. 1.

As part of the low pressure portion 2 of the rotor assembly in a low pressure section 19 of the rotor shaft 1, there may be at least one low pressure rotor blade provided (not shown in FIG. 1). Similarly to the high pressure module, there may be more than one low pressure rotor blade stage and one or more low pressure diaphragms provided.

The functioning of the transformation of thermal energy from the reheat steam into rotational energy is performed equivalently to the transformation in the high pressure chamber 12. The cooled down and expanded steam leaves the lower pressure chamber 12 through low pressure exhaust or low pressure outlet 17.

The high pressure chamber 12 and the low pressure chamber 13 are separated by a common wall 6. The common wall 6 extends radially from the rotor shaft 1 outwards. The common wall is thus facing the high pressure chamber 12 as well as the low pressure chamber 13, separating the two chambers or modules of the reheat steam turbine. The common wall 6 has also a shaft end 7 facing the rotor shaft 1 as well as an outer end facing a projection 20 of the casing 11 in a barrel design. The projection 20 extends from the inner side of the casing 11 surrounding the complete circumference of the casing 11.

Between the shaft end 7 of the common wall 6 and the rotor shaft 1, there may be a rotor sealing 9 provided in the form of a common sealing strip, in particular a plurality of common sealing strips (not shown in FIG. 1). It should be noted that there is no contact between the rotor shaft 1 and the rotor sealing 9 in order to allow a free rotatability of the rotor assembly. The rotor sealing 9 may also be carried out as a labyrinth or labyrinth sealing.

On the other end 8 of the common wall 6 there may be a casing sealing 10 provided. It may be provided in a groove of the common wall. This casing sealing 10 may be a piston ring, particularly a plurality of piston rings (not shown in FIG. 1), surrounding the complete common wall 6. The casing sealing 10 as well as the rotor sealing 9 are instrumental to separate—together with the common wall—the high pressure chamber 12 from the low pressure chamber 13. Because the casing 11 builds a common casing for the high pressure chamber 12 and the low pressure chamber 13, the common wall 6 separates at the same time the high pressure module from the low pressure module.

In case the reheat steam turbine comprises more than two modules, i.e., three modules, the low pressure chamber/module may indeed be an intermediate-pressure chamber. In this case, an additional low pressure chamber may be coupled to the reheat steam turbine in a known manner. Additionally, there may be provided a gearbox for adjusting the rotational speed of the reheat steam turbine to a required rotational speed of a generator shaft of an electrical generator.

Additionally to the projection 20 of the casing 11, there may be a stopper 21 provided to which the common wall 6 may be attached. Such a stopper may be provided in the form of a diaphragm carrier. The diaphragm carrier may couple all available diaphragms and the common wall together. Such an assembly of all diaphragms and the common wall—together with a casing—may form a stator of the turbine.

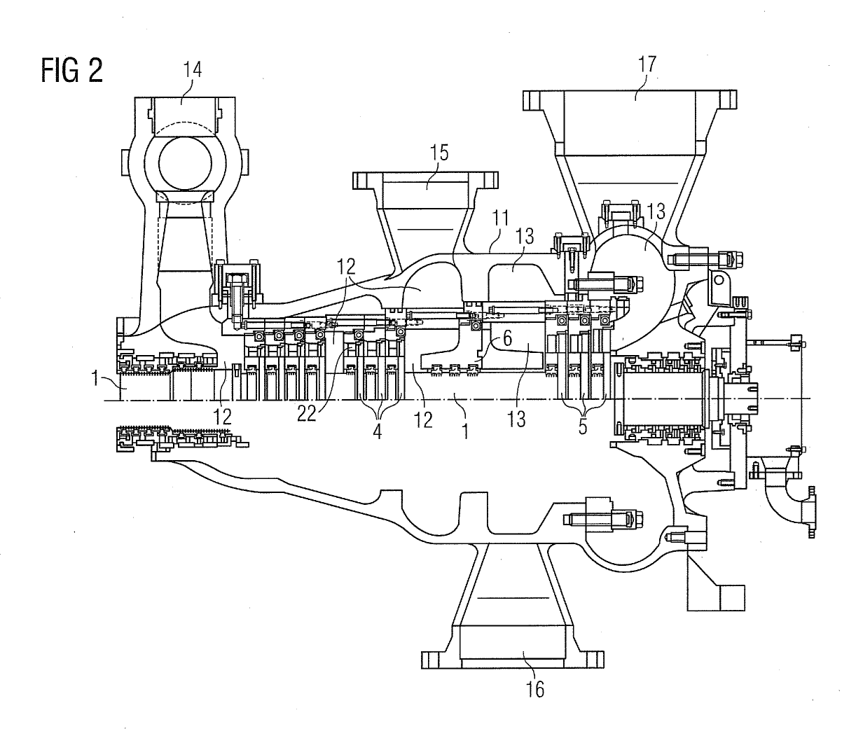

FIG. 2 shows an embodiment of the rotor assembly as well as a more detailed reheat steam turbine. On the top of FIG. 2, the high pressure inlet 14, the high pressure outlet 15, the low pressure inlet, and the low pressure outlet 17 are shown. The low pressure inlet 16 is shown on the bottom of FIG. 2. A casing 11 surrounds the high pressure chamber 12 and the low pressure chamber 13 in a barrel design. Recognizable are also high pressure rotor blades 4, low pressure rotor blades 5, the common wall 6, the rotor shaft 1 as well as diaphragms 22.

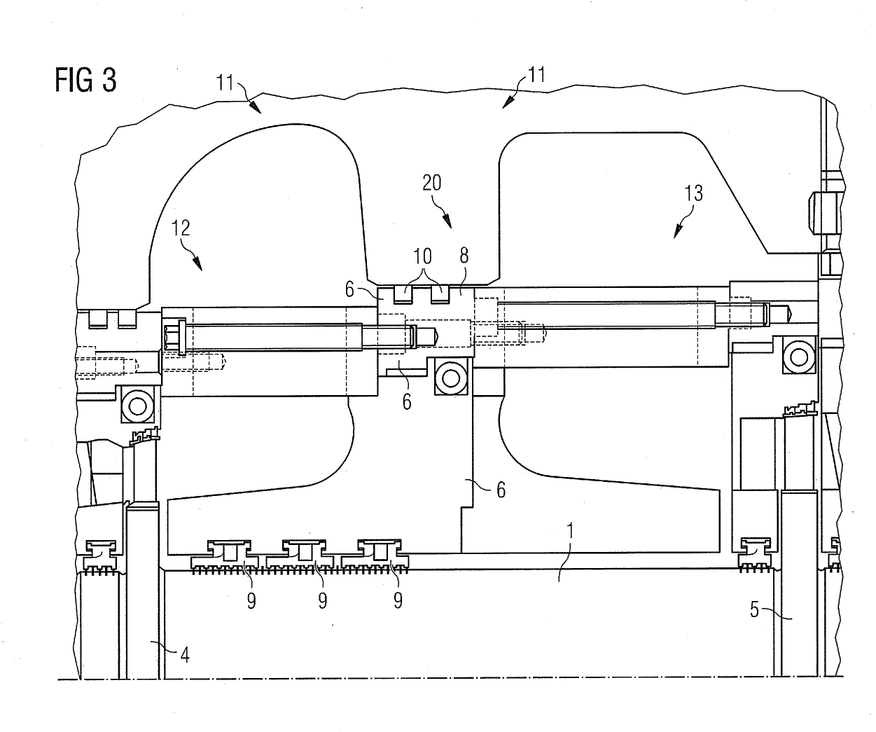

FIG. 3 shows a magnification of a central part of FIG. 2 highlighting details of the common wall 6. At the bottom of FIG. 3, the rotor shaft 1 is shown. In this embodiment, the common wall is shown to have an L-shape. One leg of the L-shaped common wall 6 extends along the rotor shaft 1. In-between the shaft end 7 of the common wall 6 and the rotor shaft 1, three rotor sealings 9 in the form of common rotor stripes are shown. They are provided along the complete circumference of the rotor shaft 1 as well as inside a groove of a central hole of the common wall 6 through which the rotor shaft 1 is extending. The other leg of the L-shaped common wall 6 extends radially towards a projection 20 of the casing 11. In-between the outer end 8 of the common wall 6 and the projection of the casing 11, a casing sealing 10, in particular a plurality of casing sealings 10, in the form of a piston ring are shown. The piston ring 10 extends throughout the complete circumference of the common wall 6 in a groove of the common wall 6 facing radially outwards. The leg of the common wall 6, extending radially, may comprise one or more separate common wall elements that may be fitted together in a known manner. It can clearly be seen that the rotor shaft 1, the rotor sealing 9, the common wall 6, and the casing sealing 10 together with the projection 20 of the casing 11, separate the high pressure chamber 12 and the low pressure chamber 13 of the reheat steam turbine.

In the embodiment shown in FIG. 2, the live steam may enter the high pressure chamber 12 of the reheat steam turbine with a temperature in the range of about 380-460° C., a pressure in the range of about 90-105 bar, and a volume in the range of about up to 1.7 m3/s for 50 MW application. Other ranges should not be excluded, e.g., steam of about 500° C. at the inlet of the high pressure inlet. The steam may leave the high pressure chamber 12 with a temperature in the range of about 300° C., a pressure in the range of a about 32 bar, and a volume in the range of about 4.2 m3/s. The reheated steam may enter the low pressure chamber 13 with a temperature in the range of about 400° C., a pressure in the range of about 30 bar, and a volume of about 5.3 m3/s. It should be noted again that these value are not limiting—they may in other embodiments vary to a wide extend.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1-12. (canceled)

13. A caseless rotor assembly for a reheat steam turbine, comprising:
a rotor shaft;
a high pressure portion with a high pressure rotor blade;
a low pressure portion with a low pressure rotor blade; and
a common wall between the high pressure portion and the low pressure portion, extending radially from the rotor shaft,
wherein the common wall comprises a shaft end oriented towards the rotor shaft and an outer end on the other side of the common wall, oriented radially outwards, and
wherein the shaft end of the common wall circularly surrounds the rotor shaft.

14. The caseless rotor assembly according to claim 13, wherein the common wall and the rotor shaft are rotatable against each other.

15. The caseless rotor assembly according to claim 13, wherein a high pressure diaphragm is provided in the high pressure portion of the rotor assembly.

16. The caseless rotor assembly according to claim 15, wherein a low pressure diaphragm is provided in the low pressure portion of the rotor assembly.

17. The caseless rotor assembly according to claim 16, wherein the high pressure diaphragm, the low pressure diaphragm and the common wall are fixed against each other by a diaphragm carrier.

18. The caseless rotor assembly according to claim 13, wherein the rotor assembly further comprises a rotor sealing between the rotor shaft and the shaft end of the common wall.

19. The caseless rotor assembly according to claim 18, wherein the rotor sealing is a common sealing strip.

20. The caseless rotor assembly according to claim 13, wherein the outer end of the common wall comprises a casing sealing.

21. The caseless rotor assembly according to claim 20, wherein the casing sealing is a piston ring.

22. A reheat steam turbine, comprising:
a rotor assembly, comprising:
a rotor shaft,
a high pressure portion with a high pressure rotor blade,
a low pressure portion with a low pressure rotor blade, and
a common wall between the high pressure portion and the low pressure portion, extending radially from the rotor shaft,
wherein the common wall comprises a shaft end oriented towards the rotor shaft and an outer end on the other side of the common wall, oriented radially outwards, and
wherein the shaft end of the common wall circularly surrounds the rotor shaft,
a stator assembly, comprising:
a casing surrounding the rotor assembly, the casing including a high pressure chamber and a low pressure chamber,
wherein the common wall separates the high pressure chamber and the low pressure chamber.

23. The reheat steam turbine according to claim 22,
wherein the casing sealing of the rotor assembly faces a projection of an inner side of the casing that is radially oriented towards the common wall, and
wherein the casing sealing tightens the high pressure chamber against the low pressure chamber.

24. The reheat steam turbine according to claim 22, wherein the common wall and the rotor shaft are rotatable against each other.

25. The reheat steam turbine according to claim 22, wherein a high pressure diaphragm is provided in the high pressure portion of the rotor assembly.

26. The reheat steam turbine according to claim 25, wherein a low pressure diaphragm is provided in the low pressure portion of the rotor assembly.

27. The reheat steam turbine according to claim 26, wherein the high pressure diaphragm, the low pressure diaphragm and the common wall are fixed against each other by a diaphragm carrier.

28. The reheat steam turbine according to claim 22, wherein the rotor assembly further comprises a rotor sealing between the rotor shaft and the shaft end of the common wall.

29. The reheat steam turbine according to claim 28, wherein the rotor sealing is a common sealing strip.

30. The reheat steam turbine according to claim 22, wherein the outer end of the common wall comprises a casing sealing.

31. The reheat steam turbine according to claim 30, wherein the casing sealing is a piston ring.

32. A method for the fabrication of a caseless rotor assembly for a reheat steam turbine, the methods comprising:
providing a rotor shaft with a high pressure section and a low pressure section;
mounting a high pressure rotor blade onto the high pressure section of the rotor shaft;
providing a common wall that extends radially from the rotor shaft on the rotor shaft; and
mounting a low pressure rotor blade onto the low pressure section of the rotor shaft.
